(19) United States
(12) Patent Application Publication
(10) Pub. No.: US 2014/0282836 A1
(43) Pub. Date: Sep. 18, 2014

(54) ENTERPRISE DEVICE POLICY MANAGEMENT

(71) Applicant: MICROSOFT CORPORATION, Redmond, WA (US)

(72) Inventors: Zhi Cai, Redmond, WA (US); Monty Jain, Redmond, WA (US); Alexei Boudzko, Redmond, WA (US); Gunnar Kudrjavets, Kirkland, WA (US); Yuhang Zhu, Bellevue, WA (US); Daniel Kevin McBride, Redmond, WA (US); Clifford Paul Strom, Sammamish, WA (US)

(73) Assignee: Microsoft Corporation, Redmond, WA (US)

(21) Appl. No.: 13/842,018

(22) Filed: Mar. 15, 2013

(51) Int. Cl. H04L 29/06

(52) U.S. Cl. CPC H04L 63/20
USPC 726/1

(57) ABSTRACT

When receiving multiple security policy configurations from different management sources, a computer device can apply the most secure of the policy configurations to the device. If one of the policy configurations is removed from the device, a determination can be made regarding which of the remaining security policy configurations is the most secure. Once the determination is made, one of the remaining security policies that is the most secure is applied.

### BACKGROUND

An enterprise application is the term used to describe software applications that businesses use to assist in solving problems. In today's corporate environment, enterprise applications are complex, scalable, distributed, component-based, and mission-critical. They may be deployed on a variety of platforms, across corporate networks, intranets, or the Internet. They are often data-centric, user-friendly, and must meet stringent requirements for security, administration, and maintenance. Examples of enterprise applications can include a sales applications, marketing applications, business intelligence tools, project management applications, etc. In short, enterprise applications can be directed to applications that a business wants its employees to use.

As mobile devices become more prevalent, users want to use their personal devices in conjunction with business. For example, rather than users owning a business phone and a separate personal phone, users own a single phone with integrated business applications and data and personal applications and data.

However, a problem arises regarding policy settings on a user's personal phone. Policy settings can relate to whether a password is required, the length of the password, the password complexity, the maximum number of allowed incorrect entries, and an amount of time that a device can remain idle before becoming password locked. Other policy settings are also available. When policies are supplied from multiple sources, such as from different enterprise applications, sometimes policies can differ in regard to security level. Thus, it is difficult to know how to handle different, and sometimes conflicting, policies.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

When receiving multiple security policy configurations from different management sources, a computer device can apply the most secure of the policy configurations to the device. If one of the policy configurations is removed from the device, a determination can be made regarding which of the remaining security policy configurations is the most secure. Once the determination is made, the remaining security policy configuration that is the most secure is applied.

In one embodiment, a policy is added to a computer device, such as a mobile device. A first policy can be received that controls a function on the computer device. Example functions can include password-related features (e.g., whether a password is required, length of a password, complexity, expiration, history, incorrect entry threshold, idle time allowed before lock, etc.) Other functions can relate to whether a storage card is allowed, encryption, etc. A second policy can be received that controls the same function as the first policy. In response, a determination is made regarding which of the first or second policy is more secure. Whichever policy is deemed more secure is then applied to the device.

In another embodiment, a policy can be removed. When multiple policies were previously received for a same function, removal of one of the policies can result in re-determining which of the remaining of the multiple policies should be applied to the function.

The foregoing and other objects, features, and advantages of the invention will become more apparent from the following detailed description, which proceeds with reference to the accompanying figures.

### BRIEF DESCRIPTION OF THE DRAWINGS

FIG. 1 is an exemplary mobile device having a policy enrolling and unenrolling application.

FIG. 2 is an example system diagram illustrating an enrollment client and multiple policy settings providers.

FIG. 3 is an example system diagram illustrating an unenrollment client.

FIG. 4 is a flowchart of an embodiment for applying one of multiple policies to a device.

FIG. 5 is a flowchart of an embodiment for enrolling and unenrolling policies from a device.

FIG. 6 is an exemplary cloud environment in which enrollment and unenrollment can be used across multiple devices.

FIG. 7 is an exemplary computing environment that can store software to implement the embodiments herein.

### DETAILED DESCRIPTION

FIG. 1 is a system diagram depicting an exemplary mobile device 100 including a variety of optional hardware and software components, shown generally at 102. Any components 102 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 104, such as a cellular or satellite network.

The illustrated mobile device 100 can include a controller or processor 110 (e.g., signal processor, microprocessor, ASIC, or other control and processing logic circuitry) for performing such tasks as signal coding, data processing, input/output processing, power control, and/or other functions. An operating system 112 can control the allocation and usage of the components 102 and support for one or more application programs that are separately stored in application containers 114. The application programs can include common mobile computing applications (e.g., email applications, calendars, contact managers, web browsers, messaging applications), or any other computing application. A particular application program 115 can be used for policy enrolling and unenrolling, as further described below.

The illustrated mobile device 100 can include memory 120. Memory 120 can include non-removable memory 122 and/or removable memory 124. The non-removable memory 122 can include RAM, ROM, flash memory, a hard disk, or other well-known memory storage technologies. The removable memory 124 can include flash memory or a Subscriber Identity Module (SIM) card, which is well known in GSM communication systems, or other well-known memory storage technologies, such as “smart cards.” The memory 120 can be used for storing data and/or code for running the operating system 112 and the applications. Example data can include web pages, text, images, sound files, video data, or other data sets to be sent to and/or received from one or more network servers or other devices via one or more wired or wireless networks. The memory 120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 100 can support one or more input devices 130, such as a touchscreen 132, microphone 134, camera 136, physical keyboard 138 and/or trackball 140 and one or more output devices 150, such as a speaker 152 and a display 154. Other possible output devices (not shown) can include piezoelectric or other haptic output devices. Some devices can serve more than one input/output function. For example, touchscreen 132 and display 154 can be combined in a single input/output device. The input devices 130 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 112 or applications can comprise speech-recognition software as part of a voice user interface that allows a user to operate the device 100 via voice commands. Further, the device 100 can comprise input devices and software that allows for user interaction via a user's spatial gestures, such as detecting and interpreting gestures to provide input to a gaming application.

A wireless modem 160 can be coupled to an antenna (not shown) and can support two-way communications between the processor 110 and external devices, as is well understood in the art. The modem 160 is shown generically and can include a cellular modem for communicating with the mobile communication network 104 and/or other radio-based modems (e.g., Bluetooth 164 or Wi-Fi 162). The wireless modem 160 is typically configured for communication with one or more cellular networks, such as a GSM network for data and voice communications within a single cellular network, between cellular networks, or between the mobile device and a public switched telephone network (PSTN).

The mobile device can further include at least one input/output port 180, a power supply 182, a satellite navigation system receiver 184, such as a Global Positioning System (GPS) receiver, an accelerometer 186, and/or a physical connector 190, which can be a USB port, IEEE 1394 (FireWire) port, and/or RS-232 port. The illustrated components 102 are not required or all-inclusive, as any components can be deleted and other components can be added.

FIG. 2 is an example system diagram illustrating an enrollment client and multiple policy setting providers. Multiple enterprise management sources 1 through N (shown at 210) (where N is any integer value) can be server computers associated with multiple companies. The enterprise sources 210 can have different policies associated with a function on a computer device 216. Example functions can include password-related features (e.g., whether a password is required, length of a password, complexity, expiration, history, incorrect entry threshold, idle time allowed before lock, etc.) Other functions can relate to whether a storage card is allowed, encryption, etc. The computer device 216 can be a mobile device, such as a mobile phone, or other computer device described herein. An enrollment client 220 can receive a policy from one of the enterprise management sources together with a provider identification to indicate which source is associated with the policy. Based on the policy, the enrollment client 220 selects an appropriate policy provider, such as device lock provider 230, or other policy setting providers 232. The device lock provider 230 controls policy functions related to a password, while the other policy setting providers (which can include one or more providers) control all other policies. The device lock provider 230 can have an associated table shown at 240 that lists the provider identifications and the associated policy for each provider. The device lock provider 230 includes logic for determining which of the policies associated with the password is the most secure. The particular logic is of design choice, but exemplary logic can analyze predetermined criteria for decision making about which policy is more secure. For example, a policy that requires a longer password is more secure than a policy that requires a shorter password. Likewise, a policy that requires alpha-numeric characters is more secure than a policy that allows only numbers. Once the device lock provider 230 determines which policy is the most secure, it writes the policy to another memory location 250 for consumption by an enforcement component (not shown) within the device 216.

FIG. 3 shows an example system for unenrolling an enterprise and the policy associated with that enterprise. An icon 310 is associated with an application through which a user can selectively remove an enterprise from the computer device. In response to the user selection, the associated application retrieves a stored provider identification 314 associated with the enterprise and passes the provider identification as a parameter to an unenrollment client 220 together with a request to unenroll the associated policy. The unenrollment client passes the provider identification to the appropriate policy control, such as the device lock policy control 230. The device lock policy control 230 can thereby delete or remove the policy from the table 240. Once the policy is deleted, it may be necessary to re-determine which policy should be placed into memory location 250 as the most secure policy. Thus, the device lock policy control 230 can perform the algorithm previously discussed for determining which policy of the remaining policies is the most secure. Once determined, the policy in memory location 250 can be updated. Similar functionality can occur remotely from an enterprise management source which can communicate with an application associated with icon 310 in order to initiate an unenrollment.

FIG. 4 is a flowchart according to one embodiment for applying an enterprise policy. In process block 410, a first policy can be received from an enterprise management source, such as a server computer, for controlling a function on a computer device, such as a password. In process block 412, a second policy can be received from a second enterprise management source. The second policy can control the same function as the first policy. A simple example can be wherein the first policy requires a length of a password to be 4 digits and a second policy requires a length of password to be 6 digits. In process block 414, a determination is made which of the first or second policy is more secure. Such a determination can be made, for example, by the device lock provider 230 of FIG. 2, which can use algorithms for making such determination. In process block 416, the determined more secure policy can be applied. For example, the device lock provider can copy the determined policy to a memory location for enforcement. Other structures can be used for applying the policy to the device. In some embodiments, when the device lock provider receives different policies, they are stored in a table that is ordered according to a provider identification.

FIG. 5 is a flowchart according to another embodiment for applying and removing policies from a device. In process block 510, multiple policies can be received relating to a same function. As described above, the different policies can be received from different enterprise servers. In process block 512, a determination is made which policy to apply to the function based on which policy is more secure. In process block 514, the policy is implemented against the function, such as a password is requested to be entered that has at least a given number of digits. In process block 516, a request is received to remove the policy from the client device. The request to remove the policy can be invoked through a user input command to unenroll an enterprise management source. Removal can entail searching a table (see FIG. 3 at 240) using a provider identification as a key and deleting any policies associated with the provider identification. In process block 518, in response to the removal, a re-determination is made which of the remaining of the multiple policies to apply. Thus, the remaining policies in the table can be analyzed to determine which is the most secure and the most secure policy can be used to control the associated function in the device. Such analysis can include comparing the remaining policies in the table to determine which is the most restrictive (i.e., which has the highest security). After the re-determination is made, the most restrictive policy can be copied to a location separate from the table for consumption and enforcement.

FIG. 6 illustrates a generalized example of a suitable implementation environment 600 in which described embodiments, techniques, and technologies may be implemented.

In example environment 600, various types of services (e.g., computing services) are provided by a cloud 610. For example, the cloud 610 can comprise a collection of computing devices, which may be located centrally or distributed, that provide cloud-based services to various types of users and devices connected via a network such as the Internet. The implementation environment 600 can be used in different ways to accomplish computing tasks. For example, some tasks (e.g., processing user input and presenting a user interface) can be performed on local computing devices (e.g., connected devices 630, 640, 650) while other tasks (e.g., storage of data to be used in subsequent processing) can be performed in the cloud 610.

In example environment 600, the cloud 610 provides services for connected devices 630, 640, 650 with a variety of screen capabilities. Connected device 630 represents a device with a computer screen 635 (e.g., a mid-size screen). For example, connected device 630 could be a personal computer such as desktop computer, laptop, notebook, netbook, or the like. Connected device 640 represents a device with a mobile device screen 645 (e.g., a small size screen). For example, connected device 640 could be a mobile phone, smart phone, personal digital assistant, tablet computer, or the like. Connected device 650 represents a device with a large screen 655. For example, connected device 650 could be a television screen (e.g., a smart television) or another device connected to a television (e.g., a set-top box or gaming console) or the like. One or more of the connected devices 630, 640, 650 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 600. For example, the cloud 610 can provide services for one or more computers (e.g., server computers) without displays.

Services can be provided by the cloud 610 through service providers 620, or through other providers of online services (not depicted). For example, the service providers 620 can provide a centralized solution for various cloud-based services. In one embodiment, an enterprise server 622 can be available to enroll an enterprise and unenroll the enterprise from connected devices 630, 640, 650. The enterprise server 622 can have a list of all user devices associated with a common user account. If the server 622 enrolls a new enterprise to one of the devices, the policy can be applied to all of the devices. Similarly, if a user unenrolls an enterprise from one of the devices, the server 622 can automatically unenroll the policy from other devices on the same user account using the techniques previously described.

FIG. 7 depicts a generalized example of a suitable computing environment 700 in which the described innovations may be implemented. The computing environment 700 is not intended to suggest any limitation as to scope of use or functionality, as the innovations may be implemented in diverse general-purpose or special-purpose computing systems. For example, the computing environment 700 can be any of a variety of computing devices (e.g., desktop computer, laptop computer, server computer, tablet computer, media player, gaming system, mobile device, etc.).

With reference to FIG. 7, the computing environment 700 includes one or more processing units 710, 715 and memory 720, 725. In FIG. 7, this basic configuration 730 is included within a dashed line. The processing units 710, 715 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 7 shows a central processing unit 710 as well as a graphics processing unit or co-processing unit 715. The tangible memory 720, 725 may be volatile memory (e.g., registers, cache, RAM), non-volatile memory (e.g., ROM, EEPROM, flash memory, etc.), or some combination of the two, accessible by the processing unit(s). The memory 720, 725 stores software 780 implementing one or more innovations described herein, in the form of computer-executable instructions suitable for execution by the processing unit(s).

A computing system may have additional features. For example, the computing environment 700 includes storage 740, one or more input devices 750, one or more output devices 760, and one or more communication connections 770. An interconnection mechanism (not shown) such as a bus, controller, or network interconnects the components of the computing environment 700. Typically, operating system software (not shown) provides an operating environment for other software executing in the computing environment 700, and coordinates activities of the components of the computing environment 700.

The tangible storage 740 may be removable or non-removable, and includes magnetic disks, magnetic tapes or cassettes, CD-ROMs, DVDs, or any other medium which can be used to store information and which can be accessed within the computing environment 700. The storage 740 stores instructions for the software 780 implementing one or more innovations described herein.

The input device(s) 750 may be a touch input device such as a keyboard, mouse, pen, or trackball, a voice input device, a scanning device, or another device that provides input to the computing environment 700. For video encoding, the input device(s) 750 may be a camera, video card, TV tuner card, or similar device that accepts video input in analog or digital form, or a CD-ROM or CD-RW that reads video samples into the computing environment 700. The output device(s) 760 may be a display, printer, speaker, CD-writer, or another device that provides output from the computing environment 700.

The communication connection(s) 770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., optical media discs, volatile memory components (such as DRAM or SRAM), or nonvolatile memory components (such as flash memory or hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method of applying policy to a computer device, comprising:
receiving a first policy on the computer device, the first policy controlling a function on the computer device;
receiving a second policy on the computer device, the second policy controlling the same function on the computer device;
determining which of the first policy or second policy is more secure; and
applying the determined more secure policy to the computer device.

2. The method of claim 1, wherein the first and second policy are associated with a password used on the computer device.

3. The method of claim 1, wherein the first and second policies are received from different enterprise management sources.

4. The method of claim 1, further including receiving a third policy controlling the function on the computer device, wherein the first, second and third policies are associated with different enterprise management sources.

5. The method of claim 4, wherein the first policy is the determined more secure policy and further including unenrolling an enterprise associated with the first policy, automatically determining which of the second and third policies is more secure, and applying the more secure of the second or third policies to the computer device in place of the first policy.

6. The method of claim 5, wherein each policy is associated with a provider identification indicating a source of the policy, and unenrolling includes receiving a request to remove a policy, the request including the provider identification as a parameter.

7. A computer-readable storage storing instructions thereon for executing a method, the method comprising:
receiving multiple policies from different enterprise management sources, the multiple policies relating to a same function on a client device;
determining which one of the multiple policies to apply to the function on the client device;
implementing the determined policy against the function;
receiving a request to remove the determined policy from the client device; and
in response to removal of the determined policy, re-determining which of the remaining of the multiple policies to apply to the function.

8. The computer-readable storage of claim 7, wherein each enterprise management source is associated with a provider identification, and wherein each of the multiple policies are stored in association with its provider identification.

9. The computer-readable storage of claim 7, wherein the determining which of the multiple policies to apply to the function includes determining which of the multiple policies provides a highest level of security.

10. The computer-readable storage of claim 7, wherein the request to remove the determined policy from the client device is invoked through a user input command to unenroll an enterprise management source.

11. The computer-readable storage of claim 7, wherein the function relates to a password for unlocking the client device.

12. The computer-readable storage of claim 11, wherein the policy includes at least one of the following: password length, password complexity, password expiration, or an amount of idle time before password needs to be re-entered.

13. The computer-readable storage of claim 7, wherein the request to remove the determined policy includes a provider identification as a parameter, and the method further includes searching a table of policies using the provider identification as a key.

14. The computer-readable storage of claim 7, wherein the re-determining includes comparing the remaining policies in a table to determine which is a most restrictive policy.

15. The computer-readable storage of claim 14, further including copying the most restrictive policy after the re-determining to a location separate from table.

16. A system for applying policy on a client device, comprising:
at least one policy control for storing policies in association with provider identifications, wherein the policy control determines which of the stored policies to apply; and
an unenrollment client for requesting the policy control to remove one of the stored policies;
wherein the policy control re-determines which of the remaining stored policies to apply after removal of the one stored policy.

17. The system of claim 16, wherein the client device is a mobile phone.

18. The system of claim 16, wherein the policy control determines which of the stored policies to apply based on which policy has the highest security.

19. The system of claim 16, wherein the policy includes at least one of the following: password length, password complexity, password expiration, or an amount of idle time before password needs to be re-entered.

20. The system of claim 16, further including a user interface for receiving user commands on the client device to remove a policy.
